(19) United States
(12) Patent Application Publication
(10) Pub. No.: US 2026/0081228 A1
(43) Pub. Date: Mar. 19, 2026

(54) ELECTROLYTIC SOLUTION AND USE THEREOF

(71) Applicants: GUANGZHOU TINCI MATERIALS TECHNOLOGY CO., LTD, Guangzhou (CN); JIUJIANG TINCI MATERIALS TECHNOLOGY CO., LTD., Jiujiang (CN)

(72) Inventors: Wenlian WANG, Guangzhou (CN); Chaojun FAN, Guangzhou (CN); Weizhen FAN, Guangzhou (CN); Litao SHI, Guangzhou (CN)

(73) Assignees: GUANGZHOU TINCI MATERIALS TECHNOLOGY CO., LTD, Guangzhou (CN); JIUJIANG TINCI MATERIALS TECHNOLOGY CO., LTD., Jiujiang (CN)

(21) Appl. No.: 19/398,872

(22) Filed: Nov. 24, 2025

Related U.S. Application Data
(63) Continuation of application No. PCT/CN2023/113781, filed on Aug. 18, 2023.

(30) Foreign Application Priority Data
Jun. 7, 2023 (CN) 202310668070.3
Jun. 7, 2023 (CN) 202310668074.1

(51) Int. Cl. H01M 10/0567; H01M 10/0568; H01M 10/0569

(52) U.S. Cl. CPC H01M 10/0567; H01M 10/0568; H01M 10/0569; H01M 2300/0037

(57) ABSTRACT

An electrolytic solution and the use thereof. The electrolytic solution includes fluoroethylene carbonate and tris(vinyldimethylsilyl) phosphate; a mass percentage of the fluoroethylene carbonate ranges from 8% to 15%, a mass percentage of the tris(vinyldimethylsilyl) phosphate ranges from 0.5% to 2%, based on a total mass of the electrolytic solution; and a mass ratio of the tris(vinyldimethylsilyl) phosphate to the fluoroethylene carbonate ranges from 1:8 to 1:30.

### CROSS-REFERENCE TO RELATED APPLICATIONS

This application is a continuation of International Patent Application No. PCT/CN2023/113781, filed on Aug. 18, 2023, which claims the priority to Chinese Patent Application No. 202310668074.1, filed before the China National Intellectual Property Administration on Jun. 7, 2023, titled “ELECTROLYTIC SOLUTION AND USE THEREOF”; and claims the priority to Chinese Patent Application No. 202310668070.3, filed before the China National Intellectual Property Administration on Jun. 7, 2023, titled “ELECTROLYTIC SOLUTION AND USE THEREOF”, each of which are incorporated herein by reference in their entireties.

### TECHNICAL FIELD

The present application relates to an electrolytic solution and the use thereof, and relates to the technical field of energy.

### BACKGROUND

With the advancement of technology and the diversification of energy demands, traditional energy sources are being consumed at an accelerated rate, and countries worldwide are continuously accelerating their strategic deployment of new energy technologies.

Among these, power batteries are rising rapidly alongside the development of new energy vehicles, and energy storage batteries are expanding rapidly with the development of clean energy. Since 2017, competition in the new energy vehicle industry has become increasingly intense. Various power battery companies continuously research, develop, and update products to find chemical power systems that better adapt to the market, meeting the demands for high specific energy and battery life, with the aim of fully replacing traditional energy-powered passenger cars and buses.

Lithium-ion batteries are one of the important products in new energy technology. Traditional lithium-ion batteries use graphite to prepare the negative electrode; however, the specific capacity of graphite is 372 mAh g-1, which already struggles to meet the demands for higher specific energy in lithium-ion batteries. Therefore, researchers worldwide are increasingly focusing on silicon negative electrode materials with high specific capacity. Although silicon negative electrode materials can increase the energy density of batteries to a certain extent, during the cycling process of batteries, silicon negative electrode materials are prone to significant volume expansion. Consequently, the interface film between the negative electrode plate and the electrolytic solution is continually damaged, causing continuous decomposition of the electrolytic solution and ultimately deteriorating battery performance.

In order to solve the problem of battery performance deterioration caused by damage to the interface film between the negative electrode plate and the electrolytic solution during the cycling process of batteries including silicon negative electrode materials, researchers have proposed developing new electrolytic solution additives to construct a stable interface film on the surface of the negative electrode plate, thereby reducing the adverse effects caused by the expansion of silicon negative electrode materials. For Example, using fluoroethylene carbonate (FEC) as the electrolytic solution additive added to the electrolytic solution can form a stable interface film on the surface of the negative electrode plate, thereby effectively reducing the capacity loss caused by silicon negative electrode materials and lowering the interfacial impedance between the negative electrode plate and the electrolytic solution. However, FEC generates gas at high temperature, which can lead to battery failure or even explosion.

### SUMMARY

A first aspect of the present application provides an electrolytic solution. By applying it in a battery, the electrolytic solution not only facilitates the formation of a high-quality SEI film on the negative electrode surface, and the electrolytic solution itself exhibits low gas generation tendency at high temperature. Consequently, this facilitates the battery in achieving excellent cycle performance at room temperature, cycle performance at high temperature, and storage performance at high temperature simultaneously.

A second aspect of the present application provides an electrolytic solution. This electrolytic solution has low acidity and excellent stability. By applying it in a battery, the electrolytic solution facilitates the formation of a high-quality SEI film (for example, resistant to high temperature, with low interfacial impedance) on the surface of the negative electrode plate. Consequently, this facilitates the battery in achieving excellent electrochemical performance (for example, cycle performance at room temperature, cycle performance at high temperature, and storage performance at high temperature) simultaneously.

A third aspect of the present application provides a battery, including the above electrolytic solution, thereby exhibiting relatively excellent electrochemical performance.

The first aspect of the present application provides an electrolytic solution, including fluoroethylene carbonate and tris(vinyldimethylsilyl) phosphate;

a mass percentage of the fluoroethylene carbonate ranges from 8% to 15%, a mass percentage of the tris(vinyldimethylsilyl) phosphate ranges from 0.5% to 2%, based on the total mass of the electrolytic solution; and a mass ratio of the tris(vinyldimethylsilyl) phosphate to the fluoroethylene carbonate ranges from 1:8 to 1:30.

The electrolytic solution as described above, further including a first lithium salt with a mass percentage ranging from 6% to 14%, and the first lithium salt is lithium hexafluorophosphate.

The electrolytic solution as described above, further including a second lithium salt with a mass percentage ranging from 0.5% to 8%; and the second lithium salt is selected from the group consisting of lithium difluoro(oxalato)borate, lithium difluorophosphate, lithium bis(fluorosulfonyl)imide, lithium bis(trifluoromethanesulfonyl)imide, and a combination thereof.

The electrolytic solution as described above, the second lithium salt is lithium bis(fluorosulfonyl)imide and/or lithium difluorophosphate.

The electrolytic solution as described above, a mass percentage of the lithium bis(fluorosulfonyl)imide ranges from 1% to 8%, based on the total mass of the electrolytic solution; and/or, a mass percentage of the lithium difluorophosphate ranges from 0.5% to 1%, based on the total mass of the electrolytic solution.

The electrolytic solution as described above, further including a solvent with a mass percentage ranging from 65% to 86%.

The electrolytic solution as described above, further including a solvent with a mass percentage ranging from 72% to 76%.

The electrolytic solution as described above, the solvent includes a cyclic carbonate and an acyclic carbonate.

The electrolytic solution as described above, a mass ratio of the cyclic carbonate to the acyclic carbonate ranges from (2 to 3):(5 to 7).

The electrolytic solution as described above, further including a further additive with a mass percentage ranging from 0.003% to 4%; and the further additive is selected from the group consisting of ethylene sulfite, 1,4-butanesultone, prop-1-ene-1,3-sultone, 1,3-propanesultone, ethylene sulfate, maleic anhydride, tris(trimethylsilyl)borate, difluoroethylene carbonate, vinylene carbonate, triphenyl phosphite, and a combination thereof.

The electrolytic solution as described above, further including the further additive with a mass percentage ranging from 0.5% to 3.8%.

The second aspect of the present application provides an electrolytic solution, including fluoroethylene carbonate, tris(vinyldimethylsilyl) phosphate, and an isocyanate compound.

The electrolytic solution as described above, a mass percentage of the fluoroethylene carbonate ranges from 8% to 20%, based on the total mass of the electrolytic solution; and/or, a mass percentage of the tris(vinyldimethylsilyl) phosphate ranges from 0.5% to 2%, based on the total mass of the electrolytic solution; and/or, a mass percentage of the isocyanate compound ranges from 0.1% to 0.8%, based on the total mass of the electrolytic solution.

The electrolytic solution as described above, the isocyanate compound is selected from the group consisting of hexamethylene diisocyanate (CAS No.: 822-06-0), 1,4-phenylene diisocyanate (CAS No.: 104-49-4), trimethylsilyl isocyanate (CAS No.: 1118 Feb. 1), toluene-2,4-diisocyanate (CAS No.: 584-84-9), 3-(isocyanatopropyl)trimethoxysilane (CAS No.: 15396-00-6), 3-(isocyanatopropyl)triethoxysilane (CAS No.: 24801-88-5), 3-(isocyanatopropyl)dimethoxymethylsilane (CAS No.: 26115-72-0), 3-(isocyanatopropyl)diethoxymethylsilane (CAS No.: 33491-28-0), 3-(isocyanatopropyl)methoxydimethylsilane (CAS No.: 21116-75-6), 1-(isocyanatomethyl)trimethoxysilane (CAS No.: 78450-75-6), 1-(isocyanatomethyl)triethoxysilane (CAS No.: 132112-76-6), 1-(isocyanatomethyl)dimethoxymethylsilane (CAS No.: 406679-89-8), and a combination thereof.

The electrolytic solution as described above, the isocyanate compound is selected from the group consisting of hexamethylene diisocyanate, 1,4-phenylene diisocyanate, trimethylsilyl isocyanate, and a combination thereof.

The electrolytic solution as described above, further including a lithium salt with a mass percentage ranging from 12.5% to 17%.

The electrolytic solution as described above, the lithium salt includes a first lithium salt with a mass percentage ranging from 6% to 15%, and the first lithium salt is lithium hexafluorophosphate.

The electrolytic solution as described above, the lithium salt further includes a third lithium salt, and the third lithium salt is lithium bis(fluorosulfonyl)imide and/or lithium difluorophosphate.

The electrolytic solution as described above, a mass percentage of the lithium bis(fluorosulfonyl)imide ranges from 1% to 6%, based on the total mass of the electrolytic solution; and/or;

a mass percentage of the lithium difluorophosphate ranges from 0.5% to 1%, based on the total mass of the electrolytic solution.

The electrolytic solution as described above, the solvent is selected from the group consisting of ethylene carbonate and propylene carbonate, and a total mass percentage of ethylene carbonate and propylene carbonate ranges from 17.46% to 23.22%, based on the total mass of the electrolytic solution; and/or, the solvent is at least two selected from the group consisting of ethyl methyl carbonate, diethyl carbonate, and dimethyl carbonate, and a total mass percentage of the at least two of ethyl methyl carbonate, diethyl carbonate, and dimethyl carbonate ranges from 40.74% to 54.18%, based on the total mass of the electrolytic solution.

The electrolytic solution as described above, further including a further additive with a mass percentage ranging from 0.03% to 4%; and the further additive is selected from the group consisting of ethylene sulfite, 1,4-butanesultone, prop-1-ene-1,3-sultone, 1,3-propanesultone, ethylene sulfate, maleic anhydride, tris(trimethylsilyl)borate, difluoroethylene carbonate, vinylene carbonate, and a combination thereof.

The electrolytic solution as described above, further including the further additive with a mass percentage ranging from 0.5% to 3.8%.

A third aspect of the present application provides a battery, including the electrolytic solution as described above.

The electrolytic solution of the first aspect of the present application has a simple composition. By applying it in a battery, such as a secondary battery, the electrolytic solution not only facilitates the formation of a denser and more stable SEI film on the surface of the negative electrode plate of the secondary battery, protecting the negative electrode plate, and the electrolytic solution itself exhibits low gas generation tendency at high temperature. Consequently, this facilitates the secondary battery in achieving excellent cycle performance at room temperature, cycle performance at high temperature, and storage performance at high temperature simultaneously.

The electrolytic solution of the second aspect of the present application has a simple composition and excellent stability. By applying it in a battery, such as a secondary battery, the electrolytic solution not only facilitates the formation of a more high-temperature-resistant SEI film on the surface of the negative electrode plate of the secondary battery, and the interfacial impedance between this SEI film and the negative electrode plate is low. Consequently, this facilitates the secondary battery in achieving excellent electrochemical performance simultaneously.

The battery of the third aspect of the present application, including the electrolytic solution of the first aspect, has a dense and stable SEI film on the surface of the negative electrode plate, thereby further avoiding contact damage between the negative electrode plate and the electrolytic solution, and the battery of the present application exhibits low gas generation tendency at high temperature. Consequently, the battery of the present application has more excellent electrochemical performance, such as cycle performance at high temperature, cycle performance at low temperature, and storage performance at high temperature;

including the electrolytic solution of the second aspect, has a high-temperature-resistant SEI film on the surface of the negative electrode plate, and the interfacial impedance between the negative electrode plate and the electrolytic solution is low. Consequently, the battery of the present application has more excellent electrochemical performance, such as cycle performance at high temperature, cycle performance at low temperature, and storage performance at high temperature.

### DETAILED DESCRIPTION

In order to make the objectives, technical solutions, and advantages of the present application clearer, the technical solutions in the embodiments of the present application will be described clearly and completely below. Obviously, the described embodiments are part of the embodiments of the present application, but not all of them. Based on the embodiments in the present application, all other embodiments obtained by a person of ordinary skill in the art without making creative efforts shall fall within the protection scope of the present application.

In the prior art, when an electrolytic solution includes FEC, it can form a stable SEI film on the surface of a negative electrode plate, thereby facilitating improved cycle performance at room temperature of the battery. However, the thermal stability of FEC is poor, and it generates gas at high temperature. Therefore, when an electrolytic solution including FEC is applied in a battery, it generates gas at high temperature, leading to battery failure, which is detrimental to cycle performance at high temperature of the battery. Particularly when a mass percentage of FEC in electrolytic solution is greater than 2%, cycle performance at high temperature of the battery is poor, seriously affecting the application scenarios of the battery.

In view of this, the first aspect of the present application provides an electrolytic solution, including fluoroethylene carbonate and tris(vinyldimethylsilyl) phosphate;

a mass percentage of the fluoroethylene carbonate ranges from 8% to 15%, a mass percentage of the tris(vinyldimethylsilyl) phosphate ranges from 0.5% to 2%, based on the total mass of the electrolytic solution; and a mass ratio of the tris(vinyldimethylsilyl) phosphate to the fluoroethylene carbonate ranges from 1:8 to 1:30.

The FEC and the tris(vinyldimethylsilyl) phosphate in the present application can be common FEC and tris(vinyldimethylsilyl) phosphate in the art. They can be commercially available or prepared in the laboratory.

The electrolytic solution of the present application includes FEC and tris(vinyldimethylsilyl) phosphate in specific contents. Among them, a high content of FEC can form a stable SEI film on the surface of the negative electrode plate, which can effectively reduce the interfacial impedance between the negative electrode plate and the electrolytic solution, reduce the negative effects caused by the expansion of the negative electrode plate, and improve cycle performance at room temperature of the battery; the specific content of tris(vinyldimethylsilyl) phosphate can effectively inhibit the gas generation of FEC at high temperature, significantly improving cycle performance at high temperature and storage performance at high temperature of the battery. Therefore, the electrolytic solution of the present application can enable the battery to have excellent cycle performance at room temperature, cycle performance at high temperature, and storage performance at high temperature simultaneously.

Furthermore, when a mass ratio of the tris(vinyldimethylsilyl) phosphate to the fluoroethylene carbonate ranges from 1:8 to 1:20, the battery achieves even more excellent cycle performance at room temperature, cycle performance at high temperature, and storage performance at high temperature.

In some embodiments of the present application, the electrolytic solution further includes a first lithium salt with a mass percentage ranging from 6% to 14%, and the first lithium salt is lithium hexafluorophosphate.

It can be understood that the lithium hexafluorophosphate can be commonly used lithium hexafluorophosphate in the art. Lithium hexafluorophosphate can be commercially available or prepared in the laboratory. When the electrolytic solution includes lithium hexafluorophosphate with the above content, lithium hexafluorophosphate can passivate the positive electrode current collector, further improving electrochemical performance of the battery. Moreover, since lithium hexafluorophosphate is low-cost and easily available, the electrolytic solution including lithium hexafluorophosphate also has the advantage of low cost, suitable for wide promotion and application.

Furthermore, the electrolytic solution further includes a second lithium salt with a mass percentage ranging from 0.5% to 8%; and the second lithium salt is selected from the group consisting of lithium difluoro(oxalato)borate, lithium difluorophosphate, lithium bis(fluorosulfonyl)imide, lithium bis(trifluoromethanesulfonyl)imide, and a combination thereof.

In the present application, the second lithium salt has characteristics of excellent thermal stability and the ability to reduce the impedance of the electrolytic solution. Therefore, the electrolytic solution including the second lithium salt also has more excellent thermal stability, which can effectively improve cycle performance at high temperature of the battery. In particular, the first lithium salt and the second lithium salt act synergistically, which can significantly improve cycle life and performance at high temperature of the battery.

The inventors also found in research that lithium difluorophosphate has lower solubility and can better reduce impedance of the battery; lithium bis(fluorosulfonyl)imide has more excellent thermal stability. Therefore, when the second lithium salt is lithium bis(fluorosulfonyl)imide and/or lithium difluorophosphate, the electrochemical performance of the battery can be further improved.

The present application can further select the mass percentages of lithium bis(fluorosulfonyl)imide and lithium difluorophosphate in the electrolytic solution to further improve electrochemical performance of the battery. Exemplarily, in some embodiments of the present application, a mass percentage of the lithium bis(fluorosulfonyl)imide ranges from 1% to 8%, based on the total mass of the electrolytic solution; and/or, a mass percentage of the lithium difluorophosphate ranges from 0.5% to 1%, based on the total mass of the electrolytic solution.

The second lithium salt of the present application can be commercially available or prepared in the laboratory.

In some embodiments of the present application, when the electrolytic solution further includes a solvent with a mass percentage ranging from 65% to 68%, the viscosity of the electrolytic solution is appropriate, which can simplify the preparation process and improve electrochemical performance of the battery.

Furthermore, when the electrolytic solution further includes a solvent with a mass percentage ranging from 72% to 76%, the battery has more excellent electrochemical performance.

The present application does not particularly limit the solvent, which can be a commonly used solvent in the art. Exemplarily, the solvent can be at least two selected from the group consisting of acyclic carbonate, cyclic carbonate, fluorinated cyclic carbonate, fluorinated acyclic carbonate, acyclic carboxylate, cyclic carboxylate, and fluorinated acyclic ether. Furthermore, the solvent can be at least two selected from the group consisting of diethyl carbonate, dimethyl carbonate, ethyl methyl carbonate, methyl propyl carbonate, ethylene carbonate, propylene carbonate, methyl trifluoroethyl carbonate, difluoroethylene carbonate, ethyl acetate, propyl propionate, 1,4-butyrolactone, 1,1,2,2-tetrafluoroethyl-2,2,3,3-tetrafluoropropyl ether, and methyl nonafluorobutyl ether.

In some embodiments of the present application, when the solvent includes a cyclic carbonate and an acyclic carbonate, the obtained electrolytic solution, when applied in a battery, can further improve electrochemical performance of the battery.

The present application does not particularly limit the cyclic carbonate, which can be a commonly used cyclic carbonate in the art. Exemplarily, the cyclic carbonate can be selected from the group consisting of ethylene carbonate, propylene carbonate, and a combination thereof.

The present application does not particularly limit the acyclic carbonate, which can be a commonly used acyclic carbonate in the art. Exemplarily, the acyclic carbonate can be selected from the group consisting of ethyl methyl carbonate, diethyl carbonate, dimethyl carbonate, and a combination thereof.

Furthermore, when a mass ratio of the cyclic carbonate to the acyclic carbonate ranges from (2 to 3):(5 to 7), the cyclic carbonate and the acyclic carbonate can act synergistically, significantly improving the electrochemical performance of the battery.

The present application can also add a further additive besides FEC and tris(vinyldimethylsilyl) phosphate to the electrolytic solution according to actual needs. In some embodiments of the present application, the electrolytic solution further includes the further additive with a mass percentage ranging from 0.003% to 4%; and the further additive is selected from the group consisting of ethylene sulfite, 1,4-butanesultone, prop-1-ene-1,3-sultone, 1,3-propanesultone, ethylene sulfate, maleic anhydride, tris(trimethylsilyl)borate, difluoroethylene carbonate, vinylene carbonate, triphenyl phosphite, and a combination thereof.

In the present application, when the electrolytic solution further includes the further additive besides FEC and tris(vinyldimethylsilyl) phosphate in specific contents, electrochemical performance of the battery can be further effectively improved. Furthermore, a mass percentage of the further additive in the electrolytic solution can range from 0.5% to 3.8%.

In order to solve the problem of battery failure caused by gas generation of FEC at high temperature, adding tris(vinyldimethylsilyl) phosphate to an electrolytic solution can inhibit the gas generation of FEC at high temperature. However, in practical applications, when an electrolytic solution includes both FEC and tris(vinyldimethylsilyl) phosphate, acidity of the electrolytic solution increases, which can lead to an increase in impedance of the battery.

In the prior art, when an electrolytic solution includes tris(vinyldimethylsilyl) phosphate, during the charging and discharging process of the battery, tris(vinyldimethylsilyl) phosphate is prone to generate by-products such as phosphoric acid and fluorosilane gas, etc. Among them, phosphoric acid easily leads to an increase in acidity of the electrolytic solution, thereby causing the electrolytic solution to deteriorate and affecting electrochemical performance of the battery; when an electrolytic solution includes fluoroethylene carbonate (FEC) and an isocyanate compound, it easily leads to an increase in impedance of the battery.

In view of this, the second aspect of the present application provides an electrolytic solution, including fluoroethylene carbonate, tris(vinyldimethylsilyl) phosphate, and an isocyanate compound.

When the electrolytic solution of the present application is applied in a battery, during the charging and discharging process of the battery, the isocyanate compound can enable tris(vinyldimethylsilyl) phosphate to undergo almost no side reactions, thereby avoiding generation of phosphoric acid and improving stability of the electrolytic solution; during the charging and discharging process of the battery, the phosphate functional group of tris(vinyldimethylsilyl) phosphate can generate a low-impedance compound including phosphate salt, which can be embedded in the elastomer generated by the isocyanate compound, thereby solving the problem of high impedance caused by the isocyanate compound. Therefore, the electrolytic solution including the isocyanate compound and tris(vinyldimethylsilyl) phosphate can significantly improve stability at high temperature of the battery and reduce impedance of the battery;

moreover, during the charging and discharging process of the battery, the combined use of the isocyanate compound and FEC can form a high-quality elastic polymer SEI film on the surface of the negative electrode, which can protect the negative electrode and avoid affecting the electrochemical performance of the battery due to the expansion of the negative electrode; tris(vinyldimethylsilyl) phosphate will generate a Si—O-rich polymer film, further covering the surface of the SEI film generated by FEC and the isocyanate compound, making the SEI film more resistant to high temperature, thereby improving performance at high temperature of the battery;

in summary, the electrolytic solution of the present application can enable the battery to have excellent cycle performance at high temperature, cycle performance at room temperature, and low interfacial impedances simultaneously.

The present application can further select the mass percentages of the FEC, the tris(vinyldimethylsilyl) phosphate, and the isocyanate compound in the electrolytic solution to improve comprehensive performance of the electrolytic solution, thereby improving electrochemical performance of the battery. Exemplarily, in some embodiments of the present application, mass percentage of the fluoroethylene carbonate ranges from 8% to 20%, based on the total mass of the electrolytic solution; and/or, a mass percentage of the tris(vinyldimethylsilyl) phosphate ranges from 0.5% to 2%, based on the total mass of the electrolytic solution; and/or, a mass percentage of the isocyanate compound ranges from 0.1% to 0.8%, based on the total mass of the electrolytic solution.

In the present application, since tris(vinyldimethylsilyl) phosphate includes unsaturated bonds that can effectively form a film, when a relatively small amount of the isocyanate compound is added in the present application, tris(vinyldimethylsilyl) phosphate and a small amount of the isocyanate compound can act synergistically to form a uniformly distributed protective film on the electrode surface, improving electrochemical performance of the battery.

In particular, when a mass percentage of fluoroethylene carbonate in the electrolytic solution ranges from 8% to 20%; a mass percentage of tris(vinyldimethylsilyl) phosphate ranges from 0.5% to 2%; and a mass percentage of the isocyanate compound ranges from 0.1% to 0.8%, the battery can have more excellent electrochemical performance.

The present application does not particularly limit the FEC, which can be commonly used FEC in the art. For Example, the FEC can be commercially available or prepared in the laboratory.

The present application does not particularly limit the tris(vinyldimethylsilyl) phosphate, which can be commonly used tris(vinyldimethylsilyl) phosphate in the art. For Example, the tris(vinyldimethylsilyl) phosphate can be commercially available or prepared in the laboratory.

The present application does not particularly limit the isocyanate compound, which can be a commonly used isocyanate compound in the art. For Example, the isocyanate compound can be selected from the group consisting of hexamethylene diisocyanate, 1,4-phenylene diisocyanate, trimethylsilyl isocyanate, toluene-2,4-diisocyanate, 3-(isocyanatopropyl)trimethoxysilane, 3-(isocyanatopropyl)triethoxysilane, 3-(isocyanatopropyl)dimethoxymethylsilane, 3-(isocyanatopropyl)diethoxymethylsilane, 3-(isocyanatopropyl)methoxydimethylsilane, 1-(isocyanatomethyl)trimethoxysilane, 1-(isocyanatomethyl)triethoxysilane, 1-(isocyanatomethyl)dimethoxymethylsilane, and a combination thereof.

Furthermore, when the isocyanate compound is selected from the group consisting of hexamethylene diisocyanate, 1,4-phenylene diisocyanate, trimethylsilyl isocyanate, and a combination thereof, electrochemical performance of the battery can be further improved.

The above isocyanate compounds of the present application can all be commercially available or prepared in the laboratory.

In some embodiments of the present application, when the electrolytic solution further includes a lithium salt with a mass percentage ranging from 12.5% to 17%, the electrolytic solution can have an appropriate viscosity and improve ionic conductivity performance of the electrolytic solution.

The present application does not particularly limit the lithium salt, which can be selected from commonly used lithium salts in the art. Exemplarily, the lithium salt can be selected from the group consisting of lithium hexafluorophosphate, lithium difluorophosphate, lithium tetrafluoroborate, lithium bis(fluorosulfonyl)imide, lithium bis(trifluoromethanesulfonyl)imide, lithium difluoro(oxalato)borate, and a combination thereof.

In some embodiments of the present application, the lithium salt includes a first lithium salt with a mass percentage ranging from 6% to 15%, and the first lithium salt is lithium hexafluorophosphate.

It can be understood that the lithium hexafluorophosphate can be commonly used lithium hexafluorophosphate in the art. The lithium hexafluorophosphate can be commercially available or prepared in the laboratory. When the electrolytic solution includes lithium hexafluorophosphate with the above content, lithium hexafluorophosphate can passivate the positive electrode current collector, further improving electrochemical performance of the battery. Moreover, since lithium hexafluorophosphate is low-cost and easily available, the electrolytic solution including lithium hexafluorophosphate also has the advantage of low cost, suitable for wide promotion and application.

Furthermore, the electrolytic solution further includes a third lithium salt; and the third lithium salt is selected from the group consisting of lithium difluorophosphate, lithium bis(fluorosulfonyl)imide, and a combination thereof.

In the present application, lithium difluorophosphate with lower solubility can effectively reduce the impedance of the electrolytic solution. When the lithium difluorophosphate and the lithium hexafluorophosphate act synergistically, cycle life and impedance of the battery can be significantly improved.

Lithium bis(fluorosulfonyl)imide has more excellent thermal stability. When lithium the bis(fluorosulfonyl)imide and the lithium hexafluorophosphate act synergistically, cycle life and performance at high temperature of the battery can be improved without corroding the aluminum foil.

In some embodiments, when the third lithium salt includes both lithium difluorophosphate and lithium bis(fluorosulfonyl)imide, the third lithium salt is used in combination with the first lithium salt, which can further improve electrochemical performance of the battery.

The present application can further select the mass percentages of the lithium bis(fluorosulfonyl)imide and the lithium difluorophosphate in the electrolytic solution to further improve electrochemical performance of the battery. Exemplarily, in some embodiments of the present application, a mass percentage of the lithium bis(fluorosulfonyl)imide ranges from 1% to 6%, based on the total mass of the electrolytic solution; and/or, a mass percentage of the lithium difluorophosphate ranges from 0.5% to 1%, based on the total mass of the electrolytic solution.

The second lithium salt of the present application can be commercially available or prepared in the laboratory.

It can be understood that the electrolytic solution of the present application further includes a solvent. The present application does not particularly limit the solvent. The solvent can be at least two selected from the group consisting of acyclic carbonate, cyclic carbonate, fluorinated cyclic carbonate, fluorinated acyclic carbonate, acyclic carboxylate, cyclic carboxylate, and fluorinated acyclic ether. Furthermore, the solvent can be at least two selected from the group consisting of diethyl carbonate, dimethyl carbonate, ethyl methyl carbonate, methyl propyl carbonate, ethylene carbonate, propylene carbonate, methyl trifluoroethyl carbonate, difluoroethylene carbonate, ethyl acetate, propyl propionate, 1,4-butyrolactone, 1,1,2,2-tetrafluoroethyl-2,2,3,3-tetrafluoropropyl ether, and methyl nonafluorobutyl ether.

In some embodiments of the present application, when the solvent is at least two selected from the group consisting of ethylene carbonate, propylene carbonate, ethyl methyl carbonate, diethyl carbonate, and dimethyl carbonate, electrochemical performance of the battery can be further improved.

Furthermore, the present application can further select the mass percentages of ethylene carbonate, propylene carbonate, ethyl methyl carbonate, diethyl carbonate, and dimethyl carbonate in the electrolytic solution to further improve electrochemical performance of the battery. Exemplarily, in some embodiments of the present application, a total mass percentage of ethylene carbonate and propylene carbonate ranges from 17.46% to 23.22%, based on the total mass of the electrolytic solution; and/or,
a total mass percentage of the at least two of two of ethyl methyl carbonate, diethyl carbonate, and dimethyl carbonate ranges from 40.74% to 54.18%, based on the total mass of the electrolytic solution.

The present application can also add the further additive besides the FEC, the tris(vinyldimethylsilyl) phosphate, and the isocyanate compound to the electrolytic solution according to actual needs. In some embodiments of the present application, the electrolytic solution further includes the further additive with a mass percentage ranging from 0.03% to 4%; and
the further additive are selected from the group consisting of ethylene sulfite, 1,4-butanesultone, prop-1-ene-1,3-sultone, 1,3-propanesultone, ethylene sulfate, maleic anhydride, tris(trimethylsilyl)borate, difluoroethylene carbonate, vinylene carbonate, and a combination thereof.

In the present application, when the electrolytic solution further includes the further additive besides the FEC, the tris(vinyldimethylsilyl) phosphate, and the isocyanate compound in specific contents, electrochemical performance of the battery can be further effectively improved. Furthermore, a mass percentage of the further additive in the electrolytic solution can range from 0.5% to 3.8%.

A third aspect of the present application provides a battery, including the electrolytic solution of the first aspect and the second aspect of the present application.

It can be understood that, besides the above electrolytic solution, the battery further includes a positive electrode and a negative electrode.

The present application does not particularly limit the positive electrode, which can be a common positive electrode in the art. In some embodiments, positive electrode active material(s) in the positive electrode can be selected from the group consisting of lithium cobaltate, lithium iron phosphate, ternary material, and a combination thereof. Furthermore, the positive electrode active material can be a ternary material.

The present application does not particularly limit the negative electrode, which can be a common negative electrode in the art. In some embodiments, negative electrode active material(s) in the negative electrode can be selected from the group consisting of artificial graphite, natural graphite, lithium titanate, silicon, silicon-carbon, silicon-oxygen, silicon-metal compounds, and a combination thereof. Furthermore, the negative electrode active materials can be silicon-carbon and/or silicon-oxygen.

Furthermore, when the positive electrode active material is a high-nickel ternary material and the negative electrode active material is a silicon-carbon material, the obtained battery has more excellent electrochemical performance.

During specific application, the electrolytic solution of the first aspect of the present application generates a stable SEI film on the surface of the negative electrode, and the electrolytic solution is also less prone to gas generation at high temperature. Therefore, a battery including the electrolytic solution of the present application can achieve excellent cycle performance at room temperature, cycle performance at high temperature, and storage performance at high temperature simultaneously.

During specific application, the electrolytic solution of the second aspect of the present application forms a high-quality SEI film (for example, resistant to high temperature, with low interfacial impedance) on the surface of the negative electrode, thereby facilitates the battery in achieving excellent electrochemical performance (for example, cycle performance at room temperature, cycle performance at high temperature, and storage performance at high temperature) simultaneously.

Hereinafter, the electrolytic solution of the present application and its application are introduced in detail through specific Examples.

### Example 1a

The battery of this Example was prepared by a method including the following steps:

### (1) Preparation of Positive Electrode Plate

The positive electrode active material NCM811, the binder polyvinylidene fluoride (PVDF), and the conductive agent acetylene black were mixed according to a mass ratio of 96.5:2:1.5. N-methylpyrrolidone (NMP) was added, and the mixture was stirred under the action of a vacuum stirrer until the raw materials were mixed into a positive electrode slurry with uniform fluidity; and the positive electrode slurry was uniformly coated on both surfaces of an aluminum foil with a thickness of 7 μm, respectively, baked in an oven with 5 different temperature gradients, then dried in an oven at 120° C. for 8 h. Followed by rolling with the control of the compaction density of the positive electrode active layer to 3.5 g/cm³, and slitting to obtain the positive electrode plate.

### (2) Preparation of Negative Electrode Plate

The negative electrode active material carbon-SiOₓ@graphite (the mass percentage of SiOₓ was 10%), the thickener sodium carboxymethyl cellulose (CMC-Na), the binder styrene-butadiene rubber, the conductive agent acetylene black, and the conductive agent single-walled carbon nanotube (SWCNT) were mixed according to a mass ratio of 95.9:1:2:1:0.1, deionized water was added, and the mixture was stirred under the action of a vacuum stirrer to obtain a negative electrode slurry; and
the negative electrode slurry was uniformly coated on both surfaces of a copper foil with a thickness of 6 μm, respectively, dried (temperature: 85° C., time: 5 hours), rolled with the control of the compaction density of the negative electrode active layer to 1.65 g/cm³, and die-cut to obtain the negative electrode plate.

### (3) Preparation of Electrolytic Solution

In a glove box filled with argon (moisture <10 ppm, oxygen <1 ppm), ethylene carbonate (EC), diethyl carbonate (DEC), ethyl methyl carbonate (EMC), and propylene carbonate (PC) were mixed uniformly according to a mass ratio=1.5:1.5:5:2 to obtain a mixed solution. Fully dried LiPF₆, lithium difluorophosphate, FEC, and tris(vinyldimethylsilyl) phosphate were quickly added to the mixed solution to obtain the electrolytic solution;

the mass percentage of LiPF₆ was 14%, the mass percentage of lithium difluorophosphate was 0.5%, the mass percentage of FEC was 8%, the mass percentage of tris(vinyldimethylsilyl) phosphate was 0.8%, based on the total mass of the electrolytic solution, and the mass ratio of tris(vinyldimethylsilyl) phosphate to FEC was 1:10.

### (4) Preparation of Lithium-Ion Battery

The positive electrode plate from step (1), a separator, and the negative electrode plate from step (2) were sequentially stacked and then wound to obtain an un-injected bare cell;

the bare cell was placed in an outer packaging foil, the electrolytic solution from step (3) was injected into the dried bare cell, and after processes such as vacuum packaging, standing, formation, shaping, and sorting, the desired lithium-ion battery was obtained; and the separator was an 8 μm-thick coated polyethylene separator.

### Example 2a

The preparation method of the battery of this Example was substantially the same as that of Example 1a, except that:

in step (3), the mass percentage of FEC was 10%, the mass percentage of tris(vinyldimethylsilyl) phosphate was 0.5%, based on the total mass of the electrolytic solution, and the mass ratio of tris(vinyldimethylsilyl) phosphate to FEC was 1:20.

### Example 3a

The preparation method of the battery of this Example was substantially the same as that of Example 1a, except that:

in step (3), the mass percentage of FEC was 10%, the mass percentage of tris(vinyldimethylsilyl) phosphate was 1%, based on the total mass of the electrolytic solution, and the mass ratio of tris(vinyldimethylsilyl) phosphate to FEC was 1:10.

### Example 4a

The preparation method of the battery of this Example was substantially the same as that of Example 1a, except that:

in step (3), the mass percentage of FEC was 12%, the mass percentage of tris(vinyldimethylsilyl) phosphate was 0.6%, based on the total mass of the electrolytic solution, and the mass ratio of tris(vinyldimethylsilyl) phosphate to FEC was 1:20.

### Example 5a

The preparation method of the battery of this Example was substantially the same as that of Example 1a, except that:

in step (3), the mass percentage of FEC was 12%, the mass percentage of tris(vinyldimethylsilyl) phosphate was 1.2%, based on the total mass of the electrolytic solution, and the mass ratio of tris(vinyldimethylsilyl) phosphate to FEC was 1:10.

### Example 6a

The preparation method of the battery of this Example was substantially the same as that of Example 1a, except that:

in step (3), the mass percentage of FEC was 12%, the mass percentage of tris(vinyldimethylsilyl) phosphate was 1.5%, based on the total mass of the electrolytic solution, and the mass ratio of tris(vinyldimethylsilyl) phosphate to FEC was 1:8.

### Example 7a

The preparation method of the battery of this Example was substantially the same as that of Example 1a, except that:

in step (3), the mass percentage of FEC was 15%, the mass percentage of tris(vinyldimethylsilyl) phosphate was 0.5%, based on the total mass of the electrolytic solution, and the mass ratio of tris(vinyldimethylsilyl) phosphate to FEC was 1:30.

### Example 8a

The preparation method of the battery of this Example was substantially the same as that of Example 1a, except that:

in step (3), the mass percentage of FEC was 15%, the mass percentage of tris(vinyldimethylsilyl) phosphate was 1.5%, based on the total mass of the electrolytic solution, and the mass ratio of tris(vinyldimethylsilyl) phosphate to FEC was 1:10.

### Example 9a

The preparation method of the battery of this Example was substantially the same as that of Example 1a, except that:

in step (3), the mass percentage of LiPF₆ was 16.9%, based on the total mass of the electrolytic solution.

### Example 10a

The preparation method of the battery of this Example was substantially the same as that of Example 1a, except that:

in step (3), lithium bis(fluorosulfonyl)imide was used instead of lithium difluorophosphate, and the mass percentage of lithium bis(fluorosulfonyl)imide was 1%, based on the total mass of the electrolytic solution.

### Example 11a

The preparation method of the battery of this Example was substantially the same as that of Example 1a, except that:

in step (3), no lithium difluorophosphate was added, based on the total mass of the electrolytic solution.

### Example 12a

The preparation method of the battery of this Example was substantially the same as that of Example 1a, except that:

in step (3), the mass percentage of lithium difluorophosphate was 1.2%, based on the total mass of the electrolytic solution.

Comparative Example 1a

The preparation method of the battery of this Comparative Example was substantially the same as that of Example 1a, except that:

in step (3), it did not include tris(vinyldimethylsilyl) phosphate, and the mass percentage of FEC was 5%, based on the total mass of the electrolytic solution.

### Comparative Example 2a

The preparation method of the battery of this Comparative Example was substantially the same as that of Example 1a, except that:

in step (3), it did not include tris(vinyldimethylsilyl) phosphate, and the mass percentage of FEC was 12%, based on the total mass of the electrolytic solution.

### Comparative Example 3a

The preparation method of the battery of this Comparative Example was substantially the same as that of Example 1a, except that:

in step (3), the mass percentage of FEC was 5%, the mass percentage of tris(vinyldimethylsilyl) phosphate was 0.5%, based on the total mass of the electrolytic solution, and the mass ratio of tris(vinyldimethylsilyl) phosphate to FEC was 1:10.

### Comparative Example 4a

The preparation method of the battery of this Comparative Example was substantially the same as that of Example 1a, except that:

in step (3), the mass percentage of tris(vinyldimethylsilyl) phosphate was 0.4%, based on the total mass of the electrolytic solution, and the mass ratio of tris(vinyldimethylsilyl) phosphate to FEC was 1:20.

### Comparative Example 5a

The preparation method of the battery of this Comparative Example was substantially the same as that of Example 1a, except that:

in step (3), the mass percentage of tris(vinyldimethylsilyl) phosphate was 1.2%, based on the total mass of the electrolytic solution, and the mass ratio of tris(vinyldimethylsilyl) phosphate to FEC was 1:6.6.

### Comparative Example 6a

The preparation method of the battery of this Comparative Example was substantially the same as that of Example 1a, except that:

in step (3), the mass percentage of FEC was 10%, the mass percentage of tris(vinyldimethylsilyl) phosphate was 0.25%, based on the total mass of the electrolytic solution, and the mass ratio of tris(vinyldimethylsilyl) phosphate to FEC was 1:40.

### Example 1b

The battery of this Example was prepared by a method including the following steps:

### (1) Preparation of Positive Electrode Plate

The positive electrode active material NCM811, the binder polyvinylidene fluoride (PVDF), and the conductive agent acetylene black were mixed according to a mass ratio of 96.5:2:1.5, N-methylpyrrolidone (NMP) was added, and the mixture was stirred under the action of a vacuum stirrer until the raw materials were mixed into a positive electrode slurry with uniform fluidity; and
the positive electrode slurry was uniformly coated on both surfaces of an aluminum foil with a thickness of 7 μm, respectively, baked in an oven with 5 different temperature gradients, then dried in an oven at 120° C. for 8 h. Followed by rolling with the control of the compaction density of the positive electrode active layer to 3.5 g/cm³, and slitting to obtain the positive electrode plate.

### (2) Preparation of Negative Electrode Plate

The negative electrode active material carbon-SiOₓ@graphite (the mass percentage of SiOₓ was 10%), the thickener sodium carboxymethyl cellulose (CMC-Na), the binder styrene-butadiene rubber, the conductive agent acetylene black, and the conductive agent single-walled carbon nanotube (SWCNT) were mixed according to a mass ratio of 95.9:1:2:1:0.1, deionized water was added, and the mixture was stirred under the action of a vacuum stirrer to obtain a negative electrode slurry; and
the negative electrode slurry was uniformly coated on both surfaces of a copper foil with a thickness of 6 μm, respectively, dried (temperature: 85° C., time: 5 hours), rolled with the control of the compaction density of the negative electrode active layer to 1.65 g/cm³, and die-cut to obtain the negative electrode plate.

### (3) Preparation of Electrolytic Solution

In a glove box filled with argon (moisture <10 ppm, oxygen <1 ppm), ethylene carbonate (EC), diethyl carbonate (DEC), ethyl methyl carbonate (EMC), and propylene carbonate (PC) were mixed uniformly according to a mass ratio=1.5:1.5:5:2 to obtain a mixed solution. Fully dried LiPF₆, FEC, tris(vinyldimethylsilyl) phosphate, and hexamethylene diisocyanate were quickly added to the mixed solution to obtain the electrolytic solution; and
the mass percentage of LiPF₆ was 14.5%, the mass percentage of FEC was 10%, the mass percentage of tris(vinyldimethylsilyl) phosphate was 1%, and the mass percentage of hexamethylene diisocyanate was 0.1%, based on the total mass of the electrolytic solution.

### (4) Preparation of Lithium-Ion Battery

The positive electrode plate from step (1), a separator, and the negative electrode plate from step (2) were sequentially stacked and then wound to obtain an un-injected bare cell;
the bare cell was placed in an outer packaging foil, the electrolytic solution from step (3) was injected into the dried bare cell, and after processes such as vacuum packaging, standing, formation, shaping, and sorting, the desired lithium-ion battery was obtained; and the separator was an 8 μm-thick coated polyethylene separator.

### Example 2b

The preparation method of the battery of this Example was substantially the same as that of Example 1b, except that:

in step (3), the mass percentage of hexamethylene diisocyanate was 0.5%, based on the total mass of the electrolytic solution.

### Example 3b

The preparation method of the battery of this Example was substantially the same as that of Example 1b, except that:

in step (3), the mass percentage of hexamethylene diisocyanate was 0.8%, based on the total mass of the electrolytic solution.

### Example 4b

The preparation method of the battery of this Example was substantially the same as that of Example 1b, except that:

in step (3), 1,4-phenylene diisocyanate was used to replace hexamethylene diisocyanate, and the mass percentage of 1,4-phenylene diisocyanate was 0.1%, based on the total mass of the electrolytic solution.

### Example 5b

The preparation method of the battery of this Example was substantially the same as that of Example 1b, except that:

in step (3), 1,4-phenylene diisocyanate was used to replace hexamethylene diisocyanate, and the mass percentage of 1,4-phenylene diisocyanate was 0.5%, based on the total mass of the electrolytic solution.

### Example 6b

The preparation method of the battery of this Example was substantially the same as that of Example 1b, except that:

in step (3), 1,4-phenylene diisocyanate was used to replace hexamethylene diisocyanate, and the mass percentage of 1,4-phenylene diisocyanate was 0.8%, based on the total mass of the electrolytic solution.

### Example 7b

The preparation method of the battery of this Example was substantially the same as that of Example 1b, except that:

in step (3), trimethylsilyl isocyanate was used to replace hexamethylene diisocyanate, and the mass percentage of trimethylsilyl isocyanate was 0.1%, based on the total mass of the electrolytic solution.

### Example 8b

The preparation method of the battery of this Example was substantially the same as that of Example 1b, except that:

in step (3), trimethylsilyl isocyanate was used to replace hexamethylene diisocyanate, and the mass percentage of trimethylsilyl isocyanate was 0.5%, based on the total mass of the electrolytic solution.

### Example 9b

The preparation method of the battery of this Example was substantially the same as that of Example 1b, except that:

in step (3), trimethylsilyl isocyanate was used to replace hexamethylene diisocyanate, and the mass percentage of trimethylsilyl isocyanate was 0.8%, based on the total mass of the electrolytic solution.

### Example 10b

The preparation method of the battery of this Example was substantially the same as that of Example 1b, except that:

in step (3), 3-(isocyanatopropyl)triethoxysilane was used to replace hexamethylene diisocyanate, and the mass percentage of 3-(isocyanatopropyl)triethoxysilane was 0.1%, based on the total mass of the electrolytic solution.

### Example 11b

The preparation method of the battery of this Example was substantially the same as that of Example 1b, except that:

in step (3), 3-(isocyanatopropyl)triethoxysilane was used to replace hexamethylene diisocyanate, and the mass percentage of 3-(isocyanatopropyl)triethoxysilane was 0.5%, based on the total mass of the electrolytic solution.

### Example 12b

The preparation method of the battery of this Example was substantially the same as that of Example 1b, except that:

in step (3), 3-(isocyanatopropyl)triethoxysilane was used to replace hexamethylene diisocyanate, and the mass percentage of 3-(isocyanatopropyl)triethoxysilane was 0.8%, based on the total mass of the electrolytic solution.

### Example 13b

The preparation method of the battery of this Example was substantially the same as that of Example 1b, except that:

in step (3), the mass percentage of LiPF₆ was 18.9%, based on the total mass of the electrolytic solution.

### Example 14b

The preparation method of the battery of this Example was substantially the same as that of Example 1b, except that:

in step (3), a third lithium salt, lithium difluorophosphate, was further added, and the mass percentage of lithium difluorophosphate was 0.5%, based on the total mass of the electrolytic solution.

### Example 15b

The preparation method of the battery of this Example was substantially the same as that of Example 1b, except that:

in step (3), the mass percentage of fluoroethylene carbonate was 5%, based on the total mass of the electrolytic solution.

### Example 16b

The preparation method of the battery of this Example was substantially the same as that of Example 1b, except that:

in step (3), the mass percentage of tris(vinyldimethylsilyl) phosphate was 0.4%, based on the total mass of the electrolytic solution.

### Example 17b

The preparation method of the battery of this Example was substantially the same as that of Example 1b, except that:

in step (3), the mass percentage of hexamethylene diisocyanate was 1%, based on the total mass of the electrolytic solution.

### Example 18b

The preparation method of the battery of this Example was substantially the same as that of Example 1b, except that:

in step (3), 1,4-phenylene diisocyanate was used to replace hexamethylene diisocyanate, and the mass percentage of 1,4-phenylene diisocyanate was 1%, based on the total mass of the electrolytic solution.

### Example 19b

The preparation method of the battery of this Example was substantially the same as that of Example 1b, except that:

in step (3), trimethylsilyl isocyanate was used to replace hexamethylene diisocyanate, and the mass percentage of trimethylsilyl isocyanate was 1%, based on the total mass of the electrolytic solution.

### Example 20b

The preparation method of the battery of this Example was substantially the same as that of Example 1b, except that:

in step (3), 3-(isocyanatopropyl)triethoxysilane was used to replace hexamethylene diisocyanate, and the mass percentage of 3-(isocyanatopropyl)triethoxysilane was 1%, based on the total mass of the electrolytic solution.

### Comparative Example 1b

The preparation method of the battery of this Comparative Example was substantially the same as that of Example 1b, except that:

in step (3), tris(vinyldimethylsilyl) phosphate and hexamethylene diisocyanate were not added.

### Comparative Example 2b

The preparation method of the battery of this Comparative Example was substantially the same as that of Example 1b, except that:

in step (3), it did not include hexamethylene diisocyanate.

### Comparative Example 3b

The preparation method of the battery of this Comparative Example was substantially the same as that of Example 1b, except that:

in step (3), it did not include tris(vinyldimethylsilyl) phosphate, and the mass percentage of hexamethylene diisocyanate was 0.1%, based on the total mass of the electrolytic solution.

### Comparative Example 4b

The preparation method of the battery of this Comparative Example was substantially the same as that of Example 1b, except that:

in step (3), tris(trimethylsilyl) phosphate was used to replace hexamethylene diisocyanate, and the mass percentage of tris(trimethylsilyl) phosphate was 0.1%, based on the total mass of the electrolytic solution.

### Performance Testing

The batteries from the Examples and Comparative Examples were subjected to the following performance tests, and the test results are shown in Table 1a and 1b;

1) Capacity Retention Rate after Room-Temperature Cycling

The battery was charged to 4.2V at a constant current of 1 C at room temperature 25° C., charged at a constant voltage of 4.2V until the cut-off current was 0.05 C, and then discharged to 2.75 V at 1 C. The charge-discharge cycle was repeated for 500 cycles. The discharge capacity at the 500th cycle was tested and recorded, and divided by the discharge capacity at the 1st cycle to obtain the capacity retention rate.

2) Capacity Retention Rate after High-Temperature Cycling

The battery was charged to 4.2V at a constant current of 1 C at high temperature 60° C., charged at a constant voltage of 4.2V until the cut-off current was 0.05 C, and then discharged to 2.75 V at 1 C. The charge-discharge cycle was repeated for 400 cycles. The discharge capacity at the 400th cycle was tested and recorded, and divided by the discharge capacity at the 1st cycle to obtain the capacity retention rate.

### 3) Storage Thickness Test at High Temperature

The battery was charged to 4.2V at a constant current of 1 C at room temperature 25° C., charged at a constant voltage of 4.2V until the cut-off current was 0.05 C, and then discharged to 2.75V at a constant current of 1 C. The battery thickness was recorded as H1. At room temperature 25° C., the battery was charged to 4.2V at a constant current of 1 C, charged at a constant voltage of 4.2V until the cut-off current was 0.05 C, then the battery was transferred to high temperature 60° C. and stored for 7 days. Then the battery was taken out and the thickness was tested on a thickness tester, and the thickness value was recorded as H2;

$$battery thickness change rate = ( H 2 - H 1 ) / H 1 * 100 \% .$$

### 4) DCIR Test at High Temperature

The battery was charged to 4.2V at a constant current of 1 C at room temperature 25° C., charged at a constant voltage of 4.2V until the cut-off current was 0.05 C, and then discharged at a constant current of 1 C for 0.5 hours. After standing for 1 hour, it was discharged at 2 C for 10 seconds. The DCIR of the battery at 50% SOC was calculated and recorded as D1. The battery that completed the 14-day storage performance test at high temperature 60° C. was charged to 4.2V at a constant current of 1 C at room temperature 25° C., charged at a constant voltage of 4.2V until the cut-off current was 0.05 C, and then discharged at a constant current of 1 C for 0.5 hours. After standing for 1 hour, it was discharged at 2 C for 10 seconds. The DCIR of the battery at 50% SOC was calculated and recorded as D2; battery impedance change

$$rate = ( D 2 - D 1 ) / D 1 * 100 \% .$$

5) Impedance Change after Room-Temperature Cycling

The battery was charged to 4.2V at a constant current of 1 C at room temperature 25° C., charged at a constant voltage of 4.2V until the cut-off current was 0.05 C, and then discharged at a constant current of 1 C for 0.5 hours. After standing for 1 hour, it was discharged at 2 C for 10 seconds. The DCIR of the battery at 50% SOC was calculated and recorded as D3; the battery that completed the 500-cycle cycle performance test at room temperature was charged to 4.2V at a constant current of 1 C at room temperature 25° C., charged at a constant voltage of 4.2V until the cut-off current was 0.05 C, and then discharged at a constant current of 1 C for 0.5 hours. After standing for 1 hour, it was discharged at 2 C for 10 seconds. The DCIR of the battery at 50% SOC was calculated and recorded as D4. Battery impedance change=(D3−D4)/D 3*100%.

6) Acidity of Electrolytic Solution after 28-Day Storage

After the electrolytic solution was prepared, it was packaged in aluminum bottles and stored at room temperature 25° C. for 28 days. An appropriate amount of electrolytic solution 5 was taken in the glove box, and the moisture content of the electrolytic solution was tested using the low-water triethylamine method with methyl orange as an indicator.

### 7) Initial Coulombic Efficiency

The battery was first charged at a constant current of 0.1 C at 45° C. for 6.5 hours, and the capacity was recorded as D5. Next, at room temperature, it was charged to 4.2V at a constant current of 0.1 C, and charged at a constant voltage of 4.2V until the cut-off current was 0.05 C. The capacity was recorded as D6. Then, the battery was discharged to 2.75 V at 0.2 C, and the capacity was recorded as D7. Initial coulombic efficiency=D5/(D6+D7)*100%.

TABLE 1a

| | | | Capacity | Capacity |
|---|---|---|---|---|
| | | | retention | retention |
| | Thickness | Impedance | rate after | rate after |
| | change rate | change rate | 500 cycles | 400 cycles |
| | after storage | after storage | at room | at room |
| | at 60° C. | at 60° C. | temperature | temperature |
| | (%) | (%) | (%) | (%) |
| Example 1a | 3.12 | 2.89 | 90.68 | 88.79 |
| Example 2a | 12.89 | 21.12 | 91.34 | 78.69 |
| Example 3a | 5.99 | 4.21 | 93.23 | 85.99 |
| Example 4a | 18.57 | 31.99 | 92.47 | 76.38 |
| Example 5a | 6.49 | 4.94 | 92.79 | 84.67 |
| Example 6a | 5.99 | 6.95 | 89.21 | 83.98 |
| Example 7a | 23.72 | 43.68 | 91.84 | 74.97 |
| Example 8a | 7.89 | 7.82 | 90.16 | 80.89 |
| Example 9a | 4.34 | 10.54 | 88.31 | 87.79 |
| Example 10a | 3.98 | 3.85 | 90.79 | 90.01 |
| Example 11a | 4.69 | 5.03 | 87.24 | 84.23 |
| Example 12a | 3.01 | 2.45 | 91.67 | 89.15 |
| Comparative | 75.48 | 50.42 | 82.45 | 60.39 |
| Example 1a | | | | |
| Comparative | 131.42 | 90.27 | 91.79 | 10.11 |
| Example 2a | | | | |
| Comparative | 2.46 | 3.04 | 69.84 | 89.01 |
| Example 3a | | | | |
| Comparative | 55.43 | 42.36 | 87.46 | 60.47 |
| Example 4a | | | | |
| Comparative | 2.69 | 35.81 | 78.12 | 74.01 |
| Example 5a | | | | |
| Comparative | 90.49 | 88.89 | 91.97 | 23.24 |
| Example 6a | | | | |

From Table 1a, it can be seen that: by adding a specific electrolytic solution to the lithium-ion battery in the Examples of the present application, the cycle performance at room temperature and high temperature of the lithium-ion battery can be significantly improved, and the DCIR of the lithium-ion battery can be reduced.

Furthermore, from Example 1a and Example 9a, it can be seen that by further selecting the content of the first lithium salt in the electrolytic solution, impedance change rate after storage at high temperature and thickness change rate after storage at high temperature of the battery can be significantly reduced, and the capacity retention rate after room-temperature cycling and capacity retention rate after high-temperature cycling of the battery are almost unaffected. The reason is that a specific content of the lithium salt can obtain an electrolytic solution with lower viscosity, thereby improving conductivity and reducing impedance of the battery.

From Example 1a, Example 10a, and Example 11a, it can be seen that when the electrolytic solution further includes a second lithium salt, thickness change rate after storage at high temperature and impedance change rate after storage at high temperature of the battery can be reduced, and capacity retention rate after room-temperature cycling and capacity retention rate after high-temperature cycling of the battery can be improved. Lithium difluorophosphate in the second lithium salt has low impedance and excellent film-forming properties; therefore, lithium difluorophosphate can participate together with FEC and tris(vinyldimethylsilyl) phosphate in constructing the interface film. On the basis of FEC and tris(vinyldimethylsilyl) phosphate, lithium difluorophosphate reduces the interfacial impedance, and the performance of the battery is further improved. Similarly, lithium bis(fluorosulfonyl)imide has good thermal stability and high conductivity, and can also reduce battery impedance, improve electrolytic solution conductivity, and thereby improve electrochemical performance of the battery.

From Example 1a and Example 12a, it can be seen that by further selecting the content of the second lithium salt in the electrolytic solution, thickness change rate after storage at high temperature and impedance change rate after storage at high temperature of the battery are reduced, and capacity retention rate after room-temperature cycling and capacity retention rate after high-temperature cycling of the battery are improved. This is because the added second lithium salt, lithium difluorophosphate, participates in constructing a low-impedance electrode/electrolytic solution interface film, and this interface film has stable properties, which can effectively passivate the electrode interface and improve electrochemical performance of the battery.

From Example 1a and Comparative Example 1a and 2a, it can be seen that when the electrolytic solution does not include tris(vinyldimethylsilyl) phosphate, capacity retention rate after high-temperature cycling of the battery decreases significantly, and thickness change rate after storage at high temperature and impedance change rate after storage at high temperature of the battery increase significantly. This is because the gas generation problem of FEC is not solved, leading to severe gas generation in the battery and a serious decline in performance at high temperature of the battery.

From Example 1a and Comparative Example 3a, it can be seen that by specifically selecting the content of FEC in the electrolytic solution according to the present application, FEC and tris(vinyldimethylsilyl) phosphate can act synergistically, and thereby significantly improving cycle performance at room temperature of the battery.

From Example 1a and Comparative Example 4a, it can be seen that only when the content of FEC, the ratio of FEC to tris(vinyldimethylsilyl) phosphate, and the content of tris(vinyldimethylsilyl) phosphate are within the specific ranges of the present application, can a battery with excellent electrochemical performance be obtained.

From Example 1a and Comparative Example 5a and 6a, it can be seen that by making the ratio of FEC to tris(vinyldimethylsilyl) phosphate within a specific range according to the present application, electrochemical performance of the battery is effectively improved.

TABLE 1b

| | Acidity of | | | Capacity | | Capacity | |
|---|---|---|---|---|---|---|---|
| | electrolytic | | Battery | retention | | retention | |
| | solution | | thickness | rate after | Battery | rate after | Battery |
| | after | Initial | change | 400 cycles | impedance | 500 cycles | impedance |
| | storage for | coulombic | after | at high | change | at room | change |
| | 28 days | efficiency | storage at | temperature | after 400 | temperature | after 500 |
| | (HF/ppm) | (%) | 60° C. (%) | (%) | cycles (%) | (%) | cycles (%) |
| Example | 35.98 | 92.99 | 5.67 | 85.88 | 40.01 | 91.53 | 42.34 |
| 1b | | | | | | | |
| Example | 28.4 | 92.67 | 5.23 | 89.21 | 45.23 | 92.07 | 54.31 |
| 2b | | | | | | | |
| Example | 24.45 | 91.87 | 4.43 | 90.18 | 53.23 | 93.78 | 58.75 |
| 3b | | | | | | | |
| Example | 32.77 | 94.33 | 5.13 | 86.13 | 34.47 | 91.45 | 44.05 |
| 4b | | | | | | | |
| Example | 29.1 | 93.91 | 4.54 | 89.56 | 44.87 | 93.12 | 55.89 |
| 5b | | | | | | | |
| Example | 23.32 | 93.13 | 3.86 | 93.34 | 54.69 | 94.98 | 62.92 |
| 6b | | | | | | | |
| Example | 33.98 | 93.98 | 5 | 84.01 | 38.01 | 92.02 | 43.55 |
| 7b | | | | | | | |
| Example | 29.42 | 93.24 | 3.51 | 88.43 | 49.23 | 92.99 | 54.76 |
| 8b | | | | | | | |
| Example | 25.65 | 92.73 | 2.76 | 91.96 | 55.54 | 93.78 | 60.62 |
| 9b | | | | | | | |
| Example | 30.11 | 93.71 | 4.97 | 83.75 | 38.68 | 91.7 | 46.34 |
| 10b | | | | | | | |
| Example | 26.99 | 93.06 | 3.45 | 87.89 | 48.76 | 92.73 | 59.76 |
| 11b | | | | | | | |
| Example | 22.24 | 92.39 | 2.71 | 91.14 | 56.04 | 93.65 | 65.43 |
| 12b | | | | | | | |
| Example | 37.47 | 93.53 | 6.88 | 84.48 | 45.63 | 85.14 | 50.43 |
| 13b | | | | | | | |
| Example | 34.45 | 93.36 | 5.05 | 86.37 | 35.21 | 91.97 | 36.34 |
| 14b | | | | | | | |
| Example | 38.92 | 91.2 | 2.33 | 86.84 | 36.75 | 85.45 | 50.89 |
| 15b | | | | | | | |
| Example | 32.18 | 92.68 | 7.89 | 80.64 | 44.39 | 90.01 | 44.02 |
| 16b | | | | | | | |
| Example | 20.16 | 87.02 | 3.9 | 80.31 | 68.41 | 82.67 | 67.3 |
| 17b | | | | | | | |
| Example | 18.89 | 88.83 | 3.24 | 82.41 | 66.11 | 87.45 | 69.99 |
| 18b | | | | | | | |
| Example | 18.9 | 89.59 | 2.13 | 83.79 | 64.21 | 90.16 | 70.76 |
| 19b | | | | | | | |
| Example | 17.21 | 88.11 | 2.32 | 80.23 | 69.98 | 88.1 | 71.11 |
| 20b | | | | | | | |
| Comparative | 40.87 | 93.12 | 130.27 | 20.5 | 190.33 | 90.32 | 70.77 |
| Example | | | | | | | |
| 1b | | | | | | | |
| Comparative | 98 | 84.89 | 12.32 | 75.99 | 71.34 | 72.23 | 79.12 |
| Example | | | | | | | |
| 2b | | | | | | | |
| Comparative | 29.67 | 91.62 | 50.34 | 40.67 | 80.67 | 91.45 | 50.66 |
| Example | | | | | | | |
| 3b | | | | | | | |
| Comparative | 130 | 83.77 | 5.21 | 74.47 | 78.23 | 69.61 | 80.4 |
| Example | | | | | | | |
| 4b | | | | | | | |

From Table 1b, it can be seen that: by adding a specific electrolytic solution to the lithium-ion battery in the Examples of the present application, the capacity utilization rate of the lithium-ion battery can be significantly improved, cycle performance at room temperature and high temperature of the lithium-ion battery can be enhanced, and impedance of the lithium-ion battery and acidity of the electrolytic solution can be reduced.

Furthermore, from Example 1b and Example 13b, it can be seen that by further selecting the content of the first lithium salt in the electrolytic solution, cycle performance at room temperature of the lithium-ion battery can be significantly improved and impedance change rate after high-temperature cycling of the lithium-ion battery can be reduced, and acidity of the electrolytic solution, initial coulombic efficiency and cycle performance at high temperature of the lithium-ion battery are substantially unaffected. By further selecting the lithium salt in the present application, an electrolytic solution with lower viscosity can be obtained and impedance of the battery can be reduced; moreover, the synergistic effect between the isocyanate and tris(vinyldimethylsilyl) phosphate not only suppresses side reactions in the electrolytic solution but also further enhances the interface film constructed by FEC. Cycle performance at room temperature of the battery is significantly improved, and this improvement substantially has no negative impact on initial coulombic efficiency and performance at high temperature of the battery.

From Example 1b and Example 14b, it can be seen that when the electrolytic solution includes both the first lithium salt and the second lithium salt, the obtained electrolytic solution has lower acidity, and can further improve initial coulombic efficiency, cycle performance at high temperature, and cycle performance at room temperature of the battery, and reduce impedance change rate after high-temperature cycling of the battery. This is because after the addition of the second lithium salt, lithium difluorophosphate, it can participate in constructing a low-impedance electrode/electrolytic solution interface film. This interface film has stable properties, can effectively passivate the electrode interface, and further improves the interface film constructed by FEC-isocyanate-tris(vinyldimethylsilyl) phosphate, reducing the decomposition of the electrolytic solution on the electrode surface and the deposition of by-products. The impedance growth of the battery is effectively suppressed, and ultimately the electrochemical performance of the battery is improved.

From Example 1b to 3b compared with Example 17b, Example 4b to 6b compared with Example 18b, Example 7b to 9b compared with Example 19b, and Example 10b to 12b compared with Example 20b, it can be seen that by further selecting the content of the isocyanate compound in the electrolytic solution, initial coulombic efficiency, cycle performance at high temperature, and cycle performance at room temperature of the battery can be significantly improved, and impedance change rate after room-temperature cycling and impedance change rate after high-temperature cycling of the battery can be reduced. As the isocyanate content increases, the residual water and HF in the battery are eliminated more thoroughly, effectively avoiding the decomposition of the lithium salt and the damage to the electrode material by HF. Furthermore, the addition of more isocyanate makes the interface film constructed on the surface of the silicon-based material more complete and more resistant to high temperature attack, effectively suppressing side reactions in the battery. The presence of tris(vinyldimethylsilyl) phosphate can generate low-impedance phosphate ester components to construct the interface film together with the isocyanate. The problem of increased battery impedance caused by the increased number of isocyanates is also suppressed. The adverse effects of isocyanate are significantly inhibited, and electrochemical performance of the battery is significantly improved.

From Example 1b and Example 15b, it can be seen that by further selecting the content of FEC in the electrolytic solution, cycle performance at room temperature of the battery can be effectively improved, and impedance change rate after room-temperature cycling of the battery can be reduced, and initial coulombic efficiency and cycle performance at high temperature of the battery are almost unaffected. The reason is that when the content of FEC is further selected, the interface film on the electrode surface is relatively complete, and with the supplementation of the interface film by tris(vinyldimethylsilyl) phosphate and the isocyanate, cycle performance at room temperature of the battery is significantly enhanced. Additionally, with tris(vinyldimethylsilyl) phosphate inhibiting FEC gas generation and the isocyanate eliminating side reactions, the increased FEC content does not have an adverse impact on performance at high temperature of the battery; instead, the cycle performance at room temperature is significantly enhanced.

From Example 1b and Example 16b, it can be seen that by further selecting the content of tris(vinyldimethylsilyl) phosphate in the electrolytic solution, initial coulombic efficiency and cycle performance at room temperature of the battery are slightly improved, and cycle performance at high temperature of the battery is significantly enhanced. After increasing the content of tris(vinyldimethylsilyl) phosphate, the problem of FEC gas generation is significantly inhibited, side reactions on the electrode surface are significantly reduced, and performance at high temperature of the battery is markedly improved. Moreover, the low-impedance components generated by tris(vinyldimethylsilyl) phosphate also mitigate the issue of increased impedance caused by the isocyanate. Ultimately, initial coulombic efficiency and cycle performance at room temperature of the battery are also improved.

Finally, it should be noted that: the above examples are only used to illustrate the technical solutions of the present application and are not intended to limit them; although the present application has been described in detail with reference to the foregoing examples, those of ordinary skill in the art should understand that the technical solutions described in the foregoing examples can still be modified, or some or all of the technical features can be equivalently replaced; and these modifications or replacements do not cause the essence of the corresponding technical solutions to depart from the scope of the technical solutions of the examples of the present application.

1. An electrolytic solution, comprising fluoroethylene carbonate and tris(vinyldimethylsilyl) phosphate;
a mass percentage of the fluoroethylene carbonate ranges from 8% to 15%, a mass percentage of the tris(vinyldimethylsilyl) phosphate ranges from 0.5% to 2%, based on a total mass of the electrolytic solution; and
a mass ratio of the tris(vinyldimethylsilyl) phosphate to the fluoroethylene carbonate ranges from 1:8 to 1:30.

2. The electrolytic solution according to claim 1, wherein the electrolytic solution further comprises an isocyanate compound.

3. The electrolytic solution according to claim 2, wherein a mass percentage of the isocyanate compound ranges from 0.1% to 0.8%, based on a total mass of the electrolytic solution.

4. The electrolytic solution according to claim 2, wherein the isocyanate compound is selected from the group consisting of hexamethylene diisocyanate, 1,4-phenylene diisocyanate, trimethylsilyl isocyanate, toluene-2,4-diisocyanate, 3-(isocyanatopropyl)trimethoxysilane, 3-(isocyanatopropyl)triethoxysilane, 3-(isocyanatopropyl)dimethoxymethylsilane, 3-(isocyanatopropyl)diethoxymethylsilane, 3-(isocyanatopropyl)methoxydimethylsilane, 1-(isocyanatomethyl)trimethoxysilane, 1-(isocyanatomethyl)triethoxysilane, 1-(isocyanatomethyl)dimethoxymethylsilane, and a combination thereof.

5. The electrolytic solution according to claim 4, wherein the isocyanate compound is selected from the group consisting of hexamethylene diisocyanate, 1,4-phenylene diisocyanate, trimethylsilyl isocyanate, and a combination thereof.

6. The electrolytic solution according to claim 1, wherein the electrolytic solution further comprises a first lithium salt with a mass percentage ranging from 6% to 14%, and the first lithium salt is lithium hexafluorophosphate.

7. The electrolytic solution according to claim 6, wherein the electrolytic solution further comprises a second lithium salt with a mass percentage ranging from 0.5% to 8%; and the second lithium salt is selected from the group consisting of lithium difluoro(oxalato)borate, lithium difluorophosphate, lithium bis(fluorosulfonyl)imide, lithium bis(trifluoromethanesulfonyl)imide, and a combination thereof.

8. The electrolytic solution according to claim 7, wherein the second lithium salt is lithium bis(fluorosulfonyl)imide and/or lithium difluorophosphate.

9. The electrolytic solution according to claim 8, wherein a mass percentage of the lithium bis(fluorosulfonyl)imide ranges from 1% to 8%, based on a total mass of the electrolytic solution; and/or, a mass percentage of the lithium difluorophosphate ranges from 0.5% to 1%, based on a total mass of the electrolytic solution.

10. The electrolytic solution according to claim 1, wherein the electrolytic solution further comprises a solvent with a mass percentage ranging from 65% to 86%.

11. The electrolytic solution according to claim 10, wherein the electrolytic solution further comprises a solvent with a mass percentage ranging from 72% to 76%.

12. The electrolytic solution according to claim 10, wherein the solvent comprises a cyclic carbonate and an acyclic carbonate.

13. The electrolytic solution according to claim 12, wherein a mass ratio of the cyclic carbonate to the acyclic carbonate ranges from (2 to 3):(5 to 7).

14. The electrolytic solution according to claim 1, wherein the electrolytic solution further comprises a further additive with a mass percentage ranging from 0.003% to 4%; and the further additive is selected from the group consisting of ethylene sulfite, 1,4-butanesultone, prop-1-ene-1,3-sultone, 1,3-propanesultone, ethylene sulfate, maleic anhydride, tris(trimethylsilyl)borate, difluoroethylene carbonate, vinylene carbonate, triphenyl phosphite, and a combination thereof.

15. The electrolytic solution according to claim 14, wherein the electrolytic solution comprises the further additive with a mass percentage ranging from 0.5% to 3.8%.

16. A battery, comprising the electrolytic solution according to claim 1.
